(19) United States
(12) Patent Application Publication
(10) Pub. No.: US 2008/0072130 A1
(43) Pub. Date: Mar. 20, 2008

(54) Pattern-triggered measurement system

(76) Inventors: James R. Stimple, Santa Rosa, CA (US); Jady Palko, Windsor, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/444,734

(22) Filed: May 31, 2006

(51) Int. Cl. G06F 11/00

(52) U.S. Cl. 714/798

(57) ABSTRACT

A measurement system recovers a clock signal from an applied signal that includes a repeating bit pattern, provides a trigger signal synchronized to occurrences of the repeating bit pattern, acquires a set of data samples time-referenced to the trigger signal, and acquires a set of phase error samples of a phase error signal provided by a clock recovery system, wherein the acquired set of phase error samples is also time-referenced to the trigger signal.

### BACKGROUND

Data signals in some types of communication systems include repeating bit patterns that are transmitted without an accompanying clock signal. Clock recovery is used in these communication systems to extract or “recover” clock signals from the data signals, typically by phase-locking an oscillator within a clock recovery system to the data signal. However, clock recovery systems typically introduce timing errors in the recovered clock signals due to phase errors between the data signal and the recovered clock signals. Since clock signals are typically used to provide timing synchronization for receivers in the communication systems or for measurement systems that receive the data signals, there is a need to accommodate for the timing errors introduced by the clock recovery systems.

FIG. 1 shows a conventional measurement system wherein a clock recovery system is configured with a pattern detector and a digital communication analyzer (DCA). The clock recovery system provides a recovered clock signal that times sample acquisitions of the data signal in the DCA. The pattern detector pattern-triggers the sample acquisitions according to repeating occurrences of the repeating bit pattern within the data signal. This enables the DCA to measure jitter associated with designated bits within the repeating bit patterns. However, pattern-triggered measurements that are acquired using this measurement system typically include the timing errors that are introduced by the clock recovery system. Since measuring jitter associated with designated bits of the data signal can provide useful indicators of the performance a communication system, there is a need for a measurement system that accommodates for the timing errors that are introduced by the clock recovery systems in pattern-triggered measurements.

### BRIEF DESCRIPTION OF THE DRAWINGS

FIG. 1 shows a conventional measurement system.

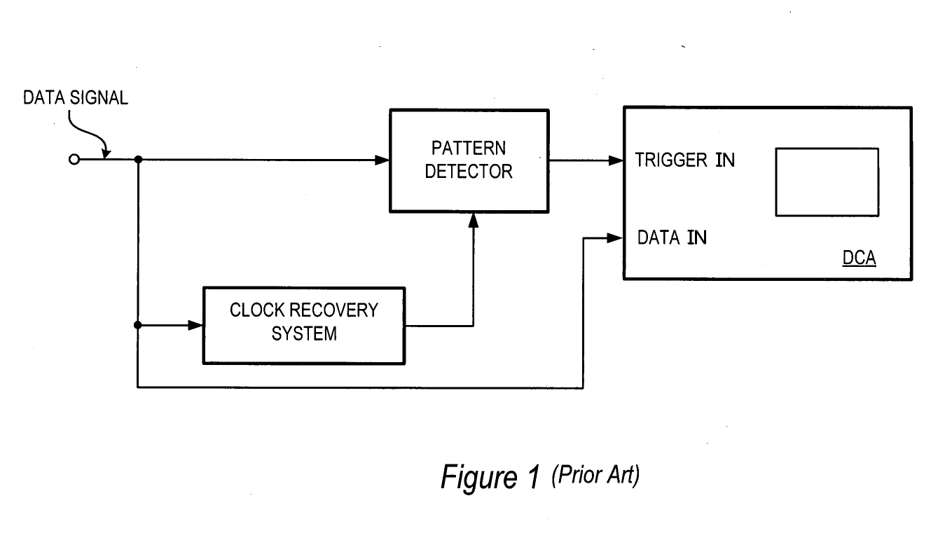

FIG. 2 shows an example of a pattern-triggered measurement system according to embodiments of the present invention.

FIG. 3A shows an example of a set of data samples acquired by the pattern-triggered measurement system of FIG. 2.

FIG. 3B shows an example measurement of data dependent jitter provided by the pattern-triggered measurement system of FIG. 2.

FIG. 4 shows an example of a clock recovery system and a triggered phase error measurement module included in the pattern-triggered measurement system of FIG. 2.

FIGS. 5A-5F show examples of measurements acquired by the pattern-triggered measurement system according to embodiments of the present invention.

FIG. 6 shows an example of a pattern-triggered measurement system according to alternative embodiments of the present invention.

### DETAILED DESCRIPTION

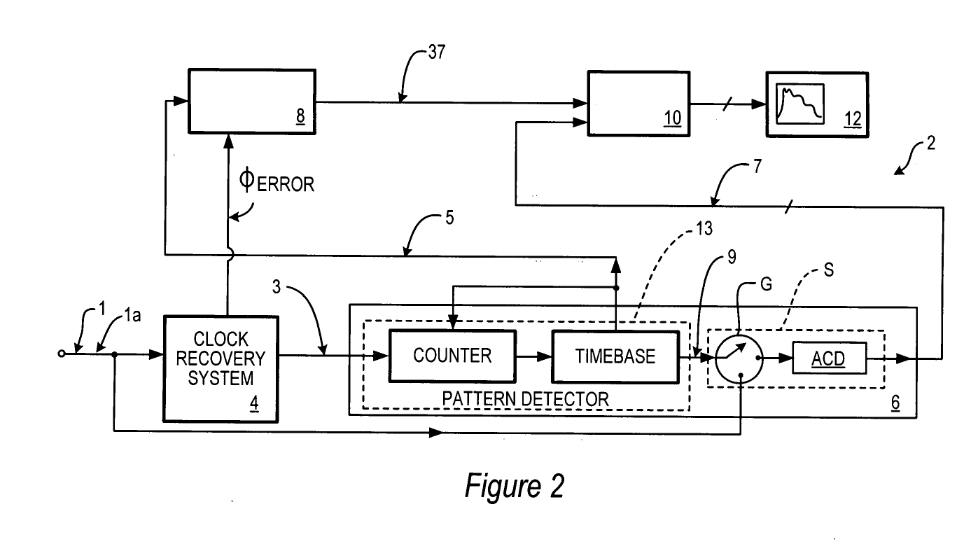

FIG. 2 shows one example of a measurement system 2 according to embodiments of the present invention. The measurement system 2 includes a clock recovery system 4 that is coupled to a pattern-triggered equivalent-time sampling system (hereinafter “sampling system 6”) and a triggered phase error measurement module (hereinafter “phase error measurement module 8”). Outputs from the phase error measurement module 8 and the sampling system 6 are provided to a signal processor 10 that is shown coupled to a display or other output device 12.

The clock recovery system 4 receives a data signal 1 that is typically a digital signal provided by a communication system, a data generator or other signal source (not shown). The data signal 1 includes a repeating pattern of bits, referred to hereinafter as a “repeating bit pattern 1a”. The clock recovery system 4 provides a recovered clock signal 3 from the applied data signal 1.

The data signal 1 and the recovered clock signal 3 are applied to the sampling system 6, which includes a pattern detector 13 and a sampler S. For the purpose of illustration, the measurement system 2 is presented in the context wherein the sampling system 6 is implemented with a digital communications analyzer (DCA), such as the model 86100C Digital Communications Analyzer by Agilent Technologies, Inc, of Palo Alto, Calif., USA. However, a pattern-triggered equivalent time oscilloscope, or other type of instrument or system can provide alternative implementations of the sampling system 6.

The sampling system 6 acquires equivalent-time samples of the data signal 1 to provide a set of data samples 7. The data samples 7 are acquired according to a strobe signal 9 that is derived from the recovered clock signal 3. The strobe signal 9 strobes a gating circuit G within the sampler S, and clocks an analog-to-digital converter ADC within the sampler S. The relative positioning of the acquired data samples 7 within the repeating bit pattern la of the data signal 1 is established according to a trigger signal 5 that is provided by the pattern detector 13, by time-referencing the acquisitions of the data samples 7 to the trigger signal 5. The trigger signal 5 includes a series of trigger events, such as rising edges, falling edges, or other designated signal attributes that are synchronized to repeating occurrences of the repeating bit pattern 1a of the data signal 1. In the example shown in FIG. 2, the pattern detector 13 includes a counter and timebase that count cycles of the recovered clock signal 3 and provide the trigger signal 5 based on the pattern length PL of the repeating bit pattern 1a. In an alternative example, the pattern detector 13 monitors the data signal 1 and provides the trigger signal 5 based on occurrences of a designated bit sequence within the repeating bit pattern 1a of the data signal 1. An example of this type of pattern detector 13 is provided in U.S. Pat. No. 6,374,388, to Hinch, hereby incorporated by reference.

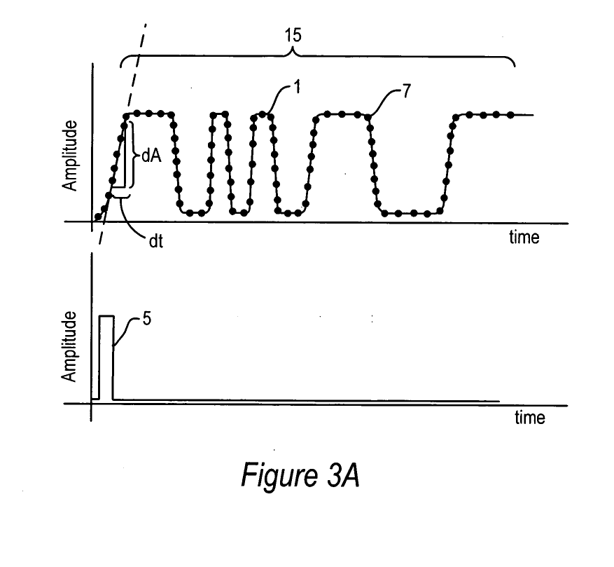

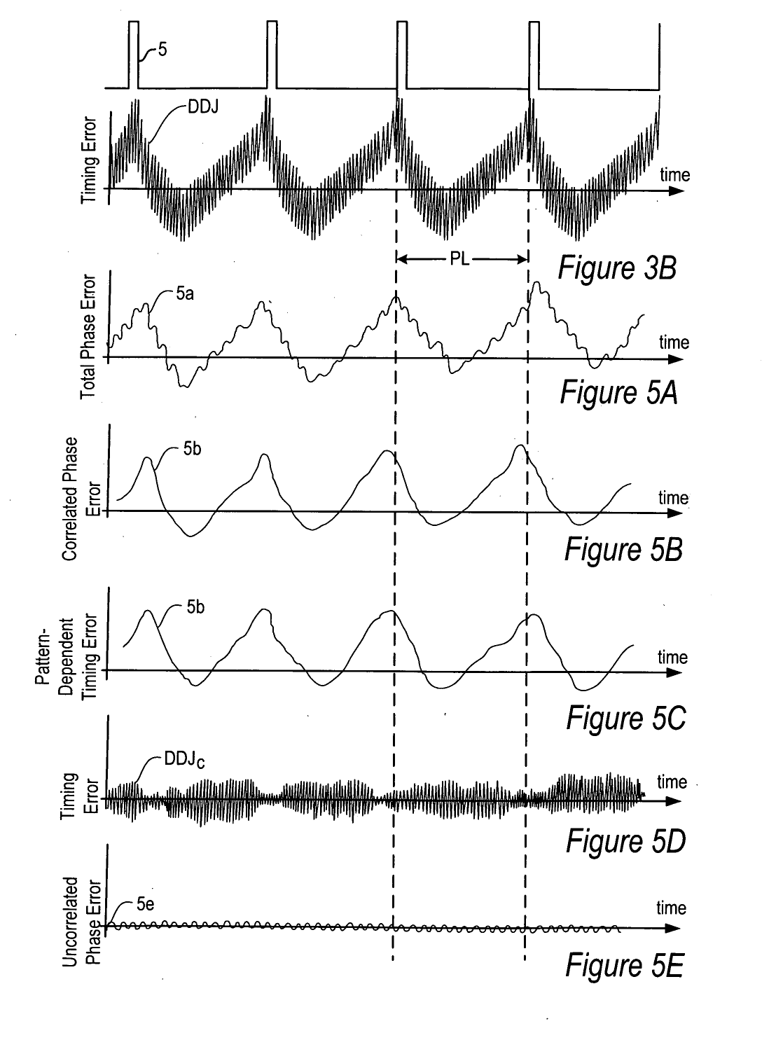

FIG. 3A shows one example of the set of data samples 7 acquired by the sampling system 6 according to the strobe signal 9, and time-referenced to the trigger signal 5. The vertical axis in FIG. 3A indicates amplitudes that are associated with designated bits within the repeating bit pattern 1a of the data signal 1, as represented by the values of the data samples 7. The horizontal axis in FIG. 3A represents time, relative to the trigger signal 5, corresponding to the positions at which designated bits 15 within the repeating bit pattern 1a of the data signal 1 occur.

The sampling system 6 also determines jitter, or timing variations, associated with transitions between logic states of bits within the repeating bit pattern 1a. These timing variations, typically referred to as data dependent jitter, can be derived from the set of data samples 7 by the signal processor 10, or by a processor (not shown) included in the sampling system 6. To derive the data dependent jitter, amplitude variations of the data samples 7 that occur on the transitions between logic states, such as the rising or falling edge transitions of the bits 15 in the data signal 1, are converted to timing variations in the occurrence of the rising or falling edge transitions of the bits 15. The conversion typically includes dividing the amplitude variations by the slope dA/dt of the corresponding edge transition for each of the bits 15.

FIG. 3B shows an example measurement of data dependent jitter DDJ associated with the applied data signal 1. The vertical axis in FIG. 3B represents timing error of the edge transitions of the bits within the repeating bit pattern 1a of the data signal 1. The timing error is typically indicated in units of time. The horizontal axis in FIG. 3B indicates time, relative to the trigger signal 5, which corresponds to the positions at which bits within the repeating bit pattern 1a of the data signal 1 occur. The data dependent jitter DDJ represents an average timing error in the occurrence of the edge transitions of each of the bits within the repeating bit pattern 1a of the data signal 1, resulting from averaging multiple sets of data samples 7 acquired from pattern-triggered measurements of the data signal 1 by the sampling system 6. The averaging is typically performed on a point by point basis, wherein data samples 7 at corresponding time positions in each of the multiple sets of data samples 7 are averaged. In one example, the measurements of data dependent jitter DDJ as shown in FIG. 3B are provided by the model 86100C DCA operating in a “jitter mode”.

The measurement of data dependent jitter DDJ, as provided in the example of FIG. 3B, includes timing errors that are associated with the recovered clock signal 3. These timing errors are introduced by the clock recovery system 4 and are typically attributed to errors between the phase of recovered clock signal 3 in the clock recovery system 4 and the phase of the data signal 1.

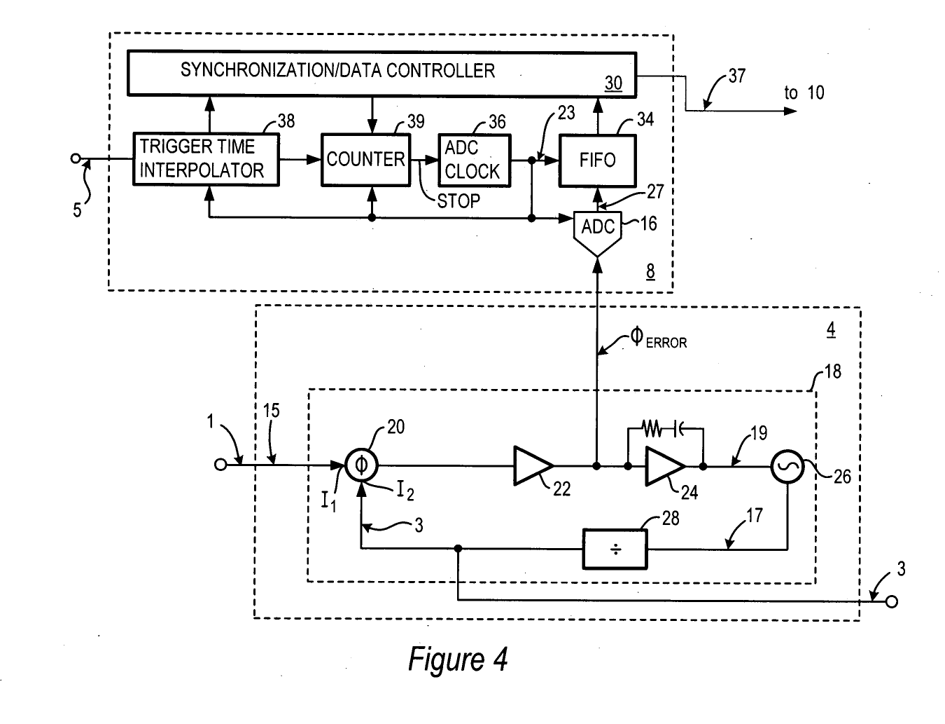

The phase error measurement module 8 (shown in FIG. 2) determines the timing errors that are associated with the recovered clock signal 3 by measuring a phase error signal φ_{ERROR} provided by the clock recovery system 4. The phase error signal φ_{ERROR} represents a total phase error between the recovered clock signal 3 and the data signal 1, which includes phase error that is correlated with the repeating bit pattern la of the data signal 1, and phase error that is not correlated with the repeating bit pattern 1a of the data signal 1. FIG. 4 shows an example of a detailed view of the clock recovery system 4 that provides the phase error signal φ_{ERROR}, and the phase error measurement module 8 that measures the phase error signal φ_{ERROR}.

The clock recovery system 4 includes a PLL 18 having a phase detector 20, an error amplifier 22, a loop integrator 24, a voltage-controlled oscillator (VCO) 26 and a frequency divider 28, each shown in block diagram form for the purpose of illustration. An example of a PLL 18 suitable for inclusion in the clock recovery system 4 is provided within a model 83495 Clock Recovery Module provided by Agilent Technologies, Inc, of Palo Alto, Calif., USA. However, alternative types of PLLs 18 that provide recovered clock signals 3 from applied data signals 1, and provide access to the phase error signal φ_{ERROR} are alternatively included in the clock recovery system 4.

Under phase-locked conditions, the PLL 18 operates in a conventional manner, providing the recovered clock signal 3 as a frequency-divided version of a signal 17 provided by the VCO 26. The data signal 1 is applied to an input I₁ of the phase detector 20, whereas the recovered clock signal 3 recovered from the data signal 1 is applied to an input I₂ of the phase detector 20. The phase detector 20 provides the phase error signal φ_{ERROR} at the output of the error amplifier 22. The phase error signal φ_{ERROR} is applied to the loop integrator 24, which provides a drive signal 19 to the VCO 26 that adjusts the frequency of the VCO 26 to minimize the phase error signal φ_{ERROR}. The PLL 18 minimizes the phase error signal φ_{ERROR} to the extent that the PLL 18 has sufficient gain and bandwidth to track signal fluctuations in the data signal 1.

The phase error signal φ_{ERROR} provided at the output of the error amplifier 22 is applied to an analog-to-digital converter (ADC) 16 within the phase error measurement module 8. The ADC 16 acquires samples of the phase error signal φ_{ERROR}, time-referenced to the trigger signal 5, to provide a set of phase error samples 27 to a FIFO 34. The FIFO 34 is coupled to a synchronization/data controller 30, and the FIFO 34 and the ADC 16 are clocked by an ADC clock 36. A trigger time interpolator 38 coupled to a counter 39, and to the synchronization/data controller 30, receives the trigger signal 5 that is applied to the measurement module 8 from the pattern detector 13.

Each of the phase error samples 27 has a value that represents the amplitude of the phase error signal φ_{ERROR}, and an associated index that represents the number of the phase error sample within the set of phase error samples 27.

The phase error samples 27 are loaded into the FIFO 34 until the registers of the FIFO 34 are filled. Once the registers are filled, prior phase error samples 27 acquired by the ADC 16, that were loaded into the FIFO 34, are shifted out of the FIFO 34 and discarded. The synchronization/data controller 30 establishes the number of phase error samples 27 that are acquired by the ADC 16 after a trigger event in the trigger signal 5. The synchronization/data controller 30 also establishes the number of phase error samples 27 that are positioned prior to the trigger event relative to the number of phase error samples 27 that are positioned after the trigger event. The synchronization/data controller 30 loads into the counter 39 the number that designates how many phase error samples 27 are positioned after the trigger event, and then the synchronization/data controller 30 arms the trigger time interpolator 38. Upon the occurrence of a trigger event, the trigger time interpolator 38 initiates a count by the counter 39 to count down from the number previously loaded into the counter 39 by the synchronization/data controller 30. Upon completion of the count, the counter 39 provides a stop signal STOP to the ADC clock 36, which stops the acquisition of phase error samples by the ADC 16. Absent the provided stop signal STOP, the ADC clock 36 clocks the ADC 16 and the FIFO 34.

The trigger time interpolator 38 measures the time interval or the fraction of a cycle of a signal 23 provided by the ADC clock 36 that occurs between the trigger event and the next cycle of the signal 23. Based on the number loaded into the counter 39 and the fraction of the cycle of the signal 23 measured by the trigger time interpolator 38, the acquired phase error samples 27 are positioned in time relative to the trigger signal 5. Time positions of the acquired phase error samples 27 are then established relative to the trigger events in the trigger signal 5 based on the period of the signal 23 provided by the ADC clock 36, the number loaded into the counter 39 and the fraction of the cycle of the signal 23 measured by the trigger time interpolator 38. One example of the phase error measurement module 8 that is suitable for acquiring samples that are time-referenced to a trigger signal 5 is provided by a sampling oscilloscope, such as a DSO model 3102A Oscilloscope, provided by AGILENT TECHNOLOGIES, INC., of Palo Alto, Calif., USA.

Positioning the acquired phase error samples 27 according to the trigger signal 5 enables the synchronization/data controller 30 to time-position the phase error samples 27 relative to occurrences of the repeating bit pattern 1a of the data signal 1. This provides for synchronization, or timing alignment between the phase error samples 27 acquired by the phase error measurement module 8, and the data samples 7 acquired by the sampling system 6. The time-aligned phase error samples 27 provide a measured phase error signal 37 at the output of the phase error measurement module 8.

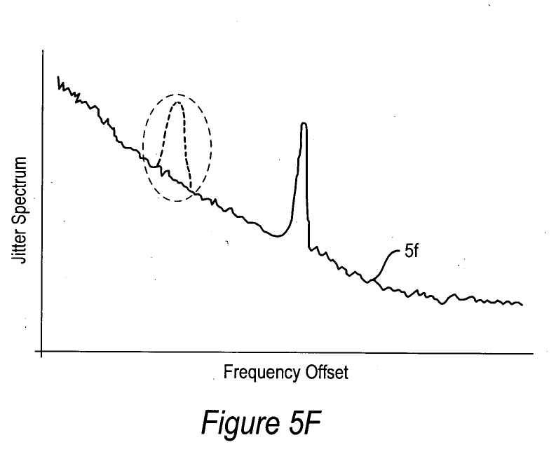

FIG. 5A shows one example of the measured phase error signal 37 wherein a set of phase error samples 27 are acquired by the phase error measurement module 8 according to the ADC clock 36, and time-referenced to the trigger signal 5. The set of phase error samples 27 in the measured phase error signal 37 of FIG. 5A represents a total phase error 5a between the recovered clock signal 3 and the data signal 1, including phase error that is correlated with the repeating bit pattern 1a in the data signal 1 and phase error that is not correlated with the repeating bit pattern 1a. The timing between trigger events in the trigger signal 5 corresponds to the pattern length PL of the repeating bit pattern 1a in the data signal 1.

In alternative examples, the phase error measurement module 8 acquires multiple sets of phase error samples 27 of the phase error signal φ_{ERROR} according to the trigger signal 5, and averages the multiple sets of acquired phase error samples 27 to provide the measured phase error signal 37. The averaging reduces phase error, as represented by the phase error signal φ_{ERROR}, that is not correlated with the trigger signal 5. Typically, averaging the multiple sets of phase error samples 27 includes averaging phase error samples 27 in each of the sets of phase error samples 27 that have corresponding indices. For example, the phase error sample in a first acquired set with the first index is averaged with the phase error samples in the other acquired sets that have the first index, the phase error sample in the first acquired set with the second index is averaged with the phase error samples in the other acquired sets that have the second index, and so on.

FIG. 5B shows an example wherein the measured phase error signal 37 includes an average of multiple sets of phase error samples 27 acquired by the phase error measurement module 8 according to the ADC clock 36, and time-referenced to the trigger signal 5 to provide time alignment between the averaged phase error samples 27 and the data samples 7 acquired by the sampling system 6. The averaged sets of phase error samples 27 in the measured phase error signal 37 shown in FIG. 5B represent the phase error that is correlated with the repeating bit pattern 1a in the data signal 1. This correlated phase error 5b is alternatively referred to as pattern-dependent phase error 5b.

FIG. 5C shows an example of pattern-dependent timing error 5c associated with the recovered clock signal 3, derived by the signal processor 10 from the pattern dependent phase error 5b shown in FIG. 5B. To derive the pattern-dependent timing error 5c, the signal processor 10 divides each of the phase error samples 27 by the transfer function of the phase detector 20 in the PLL 18, typically expressed in units of amplitude per unit of phase, such as volts/radian. The signal processor 10 then divides the result by 2πf_{CLK}, where f_{CLK} represents the frequency of the recovered clock signal 3.

According to one embodiment of the measurement system 2, the signal processor 10 subtracts the resulting pattern-dependent timing error 5c from the data dependent jitter DDJ, shown for example in FIG. 3B, to provide a corrected data dependent jitter DDJ_{C}, as shown in an example in FIG. 5D. The corrected data dependent jitter DDJ_{C} removes the timing errors introduced by the clock recovery system 4 that are correlated to the repeating bit pattern 1a of the data signal 1.

The phase error that is not correlated with the repeating bit pattern 1a of the data signal 1 can also be determined by the signal processor 10 by subtracting the correlated phase error 5b, shown for example in FIG. 5B, from the total phase error 5a, shown for example in FIG. 5A. An example of the uncorrelated phase error 5e is shown in FIG. 5E.

The signal processor 10 can also determine the jitter spectrum associated with the recovered clock signal 3, independent of pattern-dependent phase error 5b, by performing a Fourier Transform on the uncorrelated phase error 5e associated with the recovered clock signal 3. However, due to inherent gain and bandwidth limitations of the PLL 18, and performance limitations of the phase detector 20, the phase of the recovered clock signal 3 provided to the input I₂ of the phase detector 20 fails to track high frequency fluctuations in the phase of the data signal 1, which can introduce errors in the jitter spectrum. Deviation in the tracking between the phase of the clock signal 3 and the phase of the data signal 1 that results in the phase error represented by the phase error signal φ_{ERROR} depends on response characteristics, such as the loop gain and loop bandwidth of the PLL 18 within the clock recovery system 4. Typically, response characteristics of the clock recovery system 4 are represented by the impulse response or the frequency transfer function of the clock recovery system 4.

FIG. 5F shows an example jitter spectrum 5f obtained by performing a Fourier Transform on the uncorrelated phase error 5e associated with the recovered clock signal 3, corrected for the response characteristics of the clock recovery system 4. In this example, the frequency transfer function between the input to the clock recovery system 4 and the output of the error amplifier 22 is measured, calculated, or otherwise determined. This determined frequency transfer function is then multiplied by the jitter spectrum at each frequency offset from the frequency f_{CLK} of the recovered clock signal 3 to correct the jitter spectrum. Spectral components due to pattern-dependent phase error, indicated by a dashed contour in FIG. 5F, are removed from the jitter spectrum 5f.

The signal processor 10 typically includes a computer or processor with memory, sufficient to perform the disclosed mathematical operations or other relevant manipulations of the measured data signal 37 and the data samples 7 that are provided to the signal processor 10. While the signal processor 10 is shown as a separate element in FIG. 2, the signal processor 10 is alternatively included in the sampling system 6, or the phase error measurement module 8, or the signal processor 10 is distributed between these elements, or other elements of the measurement system 2.

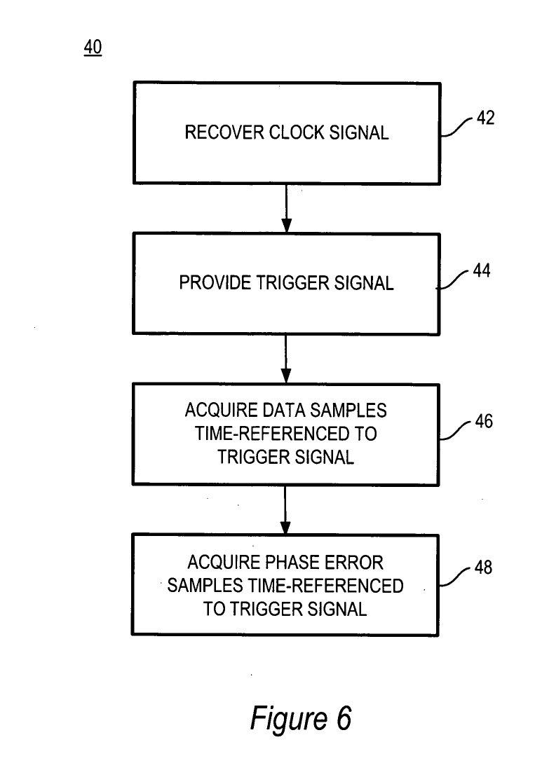

According to alternative embodiments of the present invention, the measurement system 2 is implemented according to a method 40, as shown in FIG. 6. The method 40 includes recovering the clock signal 3 from the applied data signal 1 that includes the repeating bit pattern 1a (step 42), and providing the trigger signal 5 synchronized to occurrences of the repeating bit pattern la (step 44). The method 40 then includes acquiring a set of data samples 7 of the applied data signal 1 time-referenced to the trigger signal 5 (step 46), and acquiring a set of phase error samples 27 of a phase error signal provided by a clock recovery system 4, wherein the acquired set of phase error samples 27 is also time-referenced to the trigger signal 5 (step 48).

In one example of the method 40, the set of phase error samples 27 represents the total phase error between the clock signal 3 and the data signal 1 that includes phase error that is correlated with the repeating bit pattern 1a and phase error that is uncorrelated with the repeating bit pattern 1a. In another example, the method 40 further includes determining the data dependent jitter DDJ for one or more designated bits within the repeating bit pattern 1a from the acquired set of data samples 7. In another example, the method 40 further includes averaging multiple acquired sets of phase error samples 27 to determine a phase error that is correlated with the repeating bit pattern 1a. This enables timing error associated with the clock signal to be determined based on the phase error that is correlated with the repeating bit pattern 1a of the data signal 1.

In another example, the method 40 further includes determining the phase error that is uncorrelated with the repeating bit pattern 1a, by subtracting an average of multiple acquired sets of phase error samples from the acquired set of phase error samples. In another example, the method 40 includes determining data dependent jitter DDJ for one or more designated bits within the repeating bit pattern la from the set of data samples 7, determining timing error associated with the clock signal 3 based on the phase error that is correlated with the repeating bit pattern 1a of the data signal 1, and correcting the data dependent jitter DDJ for the timing error to provide the corrected data dependent jitter DDJ_{C}.

In yet another example, the method 40 includes determining a jitter spectrum associated with the clock signal 3 based on the phase error that is uncorrelated with the repeating bit pattern 1a, and correcting the jitter spectrum for response characteristics of a phase locked loop 18 included in the clock recovery system 4.

While the embodiments of the present invention have been illustrated in detail, it should be apparent that modifications and adaptations to these embodiments may occur to one skilled in the art without departing from the scope of the present invention as set forth in the following claims.

1. A measurement system, comprising:
a clock recovery system recovering a clock signal from an applied signal that includes a repeating bit pattern;
a pattern detector providing a trigger signal synchronized to occurrences of the repeating bit pattern;
a sampling system acquiring a set of data samples of the applied signal time-referenced to the trigger signal; and
a phase error measurement module receiving the trigger signal and a phase error signal provided by the clock recovery system, and acquiring a set of phase error samples of the phase error signal to provide a measured phase error signal.

2. The measurement system of claim 1 further comprising a signal processor receiving the measured phase error signal and the set of data samples.

3. The measurement system of claim 2 wherein the signal processor determines data dependent jitter for one or more designated bits within the repeating bit pattern from the set of data samples.

4. The measurement system of claim 1 wherein the measured phase error signal represents a total phase error between the clock signal and the data signal, the total phase error including a phase error that is correlated with the repeating bit pattern and a phase error that is uncorrelated with the repeating bit pattern.

5. The measurement system of claim 1 wherein the measured phase error signal includes an average of multiple sets of acquired phase error samples, wherein the average of multiple sets of acquired phase error samples represents a phase error that is correlated with the repeating bit pattern.

6. The measurement system of claim 1 wherein the signal processor determines a phase error that is uncorrelated with the repeating bit pattern by subtracting an average of multiple sets of acquired phase error samples from one acquired set of phase error samples.

7. The measurement system of claim 4 wherein a signal processor receives the set of phase error samples and determines a phase error that is uncorrelated with the repeating bit pattern by subtracting an average of multiple sets of acquired phase error samples from the total phase error.

8. The measurement system of claim 3 wherein the signal processor determines a timing error associated with the clock signal corresponding to one or more designated bits within the repeating bit pattern based on the phase error that is correlated with the repeating bit pattern.

9. The measurement system of claim 8 wherein the signal processor corrects the data dependent jitter for the determined timing error associated with the clock signal.

10. The measurement system of claim 7 wherein the signal processor determines a jitter spectrum associated with the clock signal based on the phase error that is uncorrelated with the repeating bit pattern.

11. The measurement system of claim 10 wherein the jitter spectrum associated with the clock signal is corrected for response characteristics of a phase locked loop included in the clock recovery system.

12. A measurement system, comprising:
recovering a clock signal from an applied signal that includes a repeating bit pattern;
providing a trigger signal synchronized to occurrences of the repeating bit pattern;
acquiring a set of data samples of the applied signal time-referenced to the trigger signal; and
acquiring a set of phase error samples of a phase error signal provided by a clock recovery system wherein the acquired set of phase error samples is time-referenced to the trigger signal.

13. The measurement system of claim 12 further comprising determining data dependent jitter for one or more designated bits within the repeating bit pattern from the set of data samples.

14. The measurement system of claim 12 wherein the set of phase error samples represents a total phase error between the clock signal and the applied signal, the total phase error including a phase error that is correlated with the repeating bit pattern and a phase error that is uncorrelated with the repeating bit pattern.

15. The measurement system of claim 12 further comprising averaging multiple acquired sets of phase error samples to determine a phase error that is correlated with the repeating bit pattern.

16. The measurement system of claim 12 further comprising determining a phase error that is uncorrelated with the repeating bit pattern by subtracting an average of multiple acquired sets of phase error samples from the acquired set of phase error samples.

17. The measurement system of claim 15 further comprising determining a timing error associated with the clock signal based on the phase error that is correlated with the repeating bit pattern of the data signal.

18. The measurement system of claim 15 further comprising determining data dependent jitter for one or more designated bits within the repeating bit pattern from the set of data samples, determining a timing error associated with the clock signal based on the phase error that is correlated with the repeating bit pattern of the data signal, and correcting the data dependent jitter for the timing error.

19. The measurement system of claim 16 further comprising determining a jitter spectrum associated with the clock signal based on the phase error that is uncorrelated with the repeating bit pattern.

20. The measurement system of claim 19 further including correcting the jitter spectrum for response characteristics of a phase locked loop included in the clock recovery system.
